(19) United States
(12) Patent Application Publication
(10) Pub. No.: US 2026/0113378 A1
(43) Pub. Date: Apr. 23, 2026

(54) DYNAMIC SESSION MANAGEMENT FOR ONLINE COLLABORATION PLATFORMS

(71) Applicant: INTERNATIONAL BUSINESS MACHINES CORPORATION, ARMONK, NY (US)

(72) Inventors: Jessica Nahulan, Markham (CA); Amit Vachhani, Pune (IN); Tiberiu Suto, Franklin, NY (US)

(21) Appl. No.: 18/921,176

(22) Filed: Oct. 21, 2024

(51) Int. Cl. H04L 67/14; H04L 65/40

(52) U.S. Cl. CPC H04L 67/14; H04L 65/40

(57) ABSTRACT

An embodiment for dynamically managing sessions for online collaboration platforms is provided. The embodiment may include receiving real-time and historical data relating to an online collaboration platform session. The embodiment may also include tagging one or more items of content. The embodiment may further include based on determining at least one first tagged item of content changes after a conclusion of the online collaboration platform session, updating the at least one first tagged item of content to include new information. The embodiment may also include accessing a subsequent online collaboration platform session entered into by a second plurality of users. The embodiment may further include automatically restoring at least one second tagged item of content of the tagged one or more items of content in the subsequent online collaboration platform session that is contextually related to the online collaboration platform session.

### BACKGROUND

The present invention relates generally to the field of computing, and more particularly to a system for dynamically managing sessions for online collaboration platforms.

Online collaboration platforms have become an effective interaction and communication tool that enables both small and large-scale enterprises to reduce travel and operational costs incurred in conducting in-person meetings. The rise of remote work has transformed the way entities operate. Online teamwork and collaboration now play an important role for entities of all sizes. Demand for remote workforce management using these online collaboration platforms has increased steadily in recent years due to rapid globalization.

### SUMMARY

According to one embodiment, a method, computer system, and computer program product for dynamically managing sessions for online collaboration platforms is provided. The method, computer system, and computer program product may include receiving real-time and historical data relating to an online collaboration platform session. The method, computer system, and computer program product may also include tagging one or more items of content accessed during the online collaboration platform session and one or more actions of a first plurality of users, and associating the tagged one or more items of content and the tagged one or more actions with the online collaboration platform session in a table. The method, computer system, and computer program product may further include based on determining at least one first tagged item of content of the tagged one or more items of content changes after a conclusion of the online collaboration platform session, updating the at least one first tagged item of content to include new information based on the change. The method, computer system, and computer program product may also include accessing a subsequent online collaboration platform session entered into by a second plurality of users. The method, computer system, and computer program product may further include automatically restoring at least one second tagged item of content of the tagged one or more items of content in the subsequent online collaboration platform session that is contextually related to the online collaboration platform session.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to at least one embodiment.

FIGS. 2A and 2B illustrate an operational flowchart for dynamically managing sessions for online collaboration platforms in a dynamic online collaboration platform management process according to at least one embodiment.

FIG. 3 is an exemplary diagram depicting relevant content stored in a table according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for dynamically managing sessions for online collaboration platforms. The following described exemplary embodiments provide a system, method, and program product to, among other things, tag one or more items of content accessed during an online collaboration platform session and one or more user actions and associate them with the session in a table and, accordingly, automatically restore at least one tagged item of content in a subsequent online collaboration platform session that is contextually related to the online collaboration platform session. Therefore, the present embodiment has the capacity to improve computers by dynamically restoring relevant content from an original online collaboration platform session without any manual intervention. The present embodiment also improves a graphical user interface (GUI) by employing a one-click solution to restore relevant content in a subsequent online collaboration platform session for all users.

As previously described, online collaboration platforms have become an effective interaction and communication tool that enables both small and large-scale enterprises to reduce travel and operational costs incurred in conducting in-person meetings. The rise of remote work has transformed the way entities operate. Online teamwork and collaboration now play an important role for entities of all sizes. Demand for remote workforce management using these online collaboration platforms has increased steadily in recent years due to rapid globalization. The current landscape of digital workspace management presents numerous challenges that hinder efficiency. A core issue lies in maintaining continuity within these workplaces-a process that has proven to be cumbersome and inefficient. This problem is typically addressed by the user manually opening specific applications, URLs, and documents for different contexts and platforms. For example, upon completion of a collaboration session, the user may close their applications and then manually reopen them when entering another collaboration session. However, the manual tagging makes this process both time-consuming and prone to errors and requires the user to drill down through many layers to get to the desired data or functionality.

It may therefore be imperative to have a system in place to employ machine learning and natural language processing (NLP) technologies to reintegrate relevant content from one collaboration platform into another collaboration platform at a later time. Thus, embodiments of the present invention may provide advantages including, but not limited to, dynamically restoring relevant content from an original online collaboration platform session without any manual intervention, employing a one-click solution to restore relevant content in a subsequent online collaboration platform session for all users, and enhancing productivity. The present invention does not require that all advantages need to be incorporated into every embodiment of the invention.

According to at least one embodiment, during an online collaboration platform session, real-time and historical data relating to the online collaboration platform session may be received in order to tag one or more items of content accessed during the online collaboration platform session and one or more actions of a first plurality of users, and associate the tagged one or more items of content and the tagged one or more actions with the online collaboration platform session in a table. Upon tagging the items of content and user actions, it may be determined whether at least one first tagged item of content of the tagged one or more items of content changes after a conclusion of the online collaboration platform session. According to at least one embodiment, based on determining the at least one first tagged item of content changes, the at least one first tagged item of content may be updated to include new information based on the change so that a subsequent online collaboration platform session entered into by a second plurality of users may be accessed. Then, at least one second tagged item of content of the tagged one or more items of content may be automatically restored in the subsequent online collaboration platform session that is contextually related to the online collaboration platform session.

According to at least one other embodiment, based on determining the at least one first tagged item of content does not change, the subsequent online collaboration platform session entered into by the second plurality of users may be accessed such that the at least one second tagged item of content may be automatically restored in the subsequent online collaboration platform session that is contextually related to the online collaboration platform session.

According to at least one further embodiment, metadata may be added to one or more actions of a first user that map the one or more actions of the first user to at least one third tagged item of content of the tagged one or more items of content based on determining, via natural language processing (NLP), the one or more actions of the first user are performed responsive to a request from a second user during the online collaboration platform session in order to automatically open the at least one third tagged item of content on a device of the first user during the subsequent online collaboration platform session based on detecting a trigger word from the second user in the subsequent online collaboration platform session. In any of the above embodiments, a reminder may be generated for at least one user of the second plurality of users to work on a to-do activity within a pre-defined timeframe prior to the subsequent online collaboration platform session based on the historical data. Then, a summary of the tagged one or more items of content may be generated for at least one user of the second plurality of users having an engagement score below a threshold level.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to tag one or more items of content accessed during an online collaboration platform session and one or more user actions and associate them with the session in a table and, accordingly, automatically restore at least one tagged item of content in a subsequent online collaboration platform session that is contextually related to the online collaboration platform session.

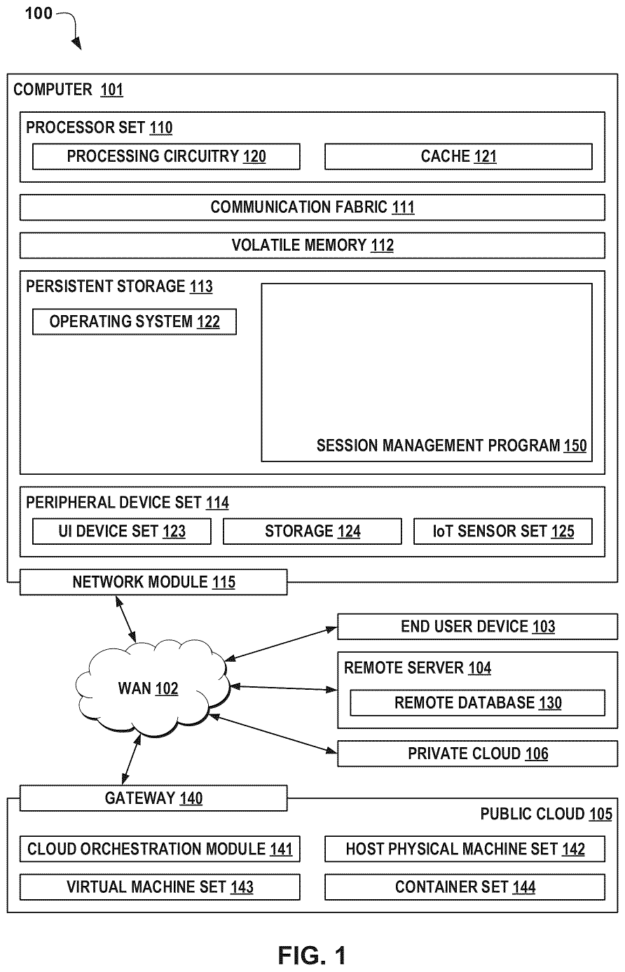

Referring to FIG. 1, an exemplary computing environment 100 is depicted, according to at least one embodiment. Computing environment 100 contains an example of an environment for the execution of at least some of the computer code involved in performing the inventive methods, such as a session management program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

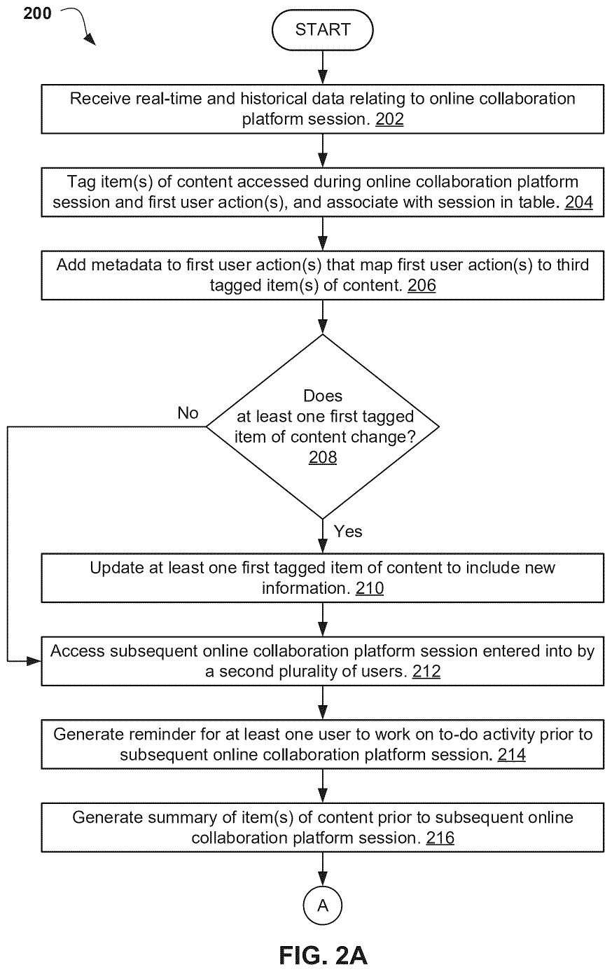

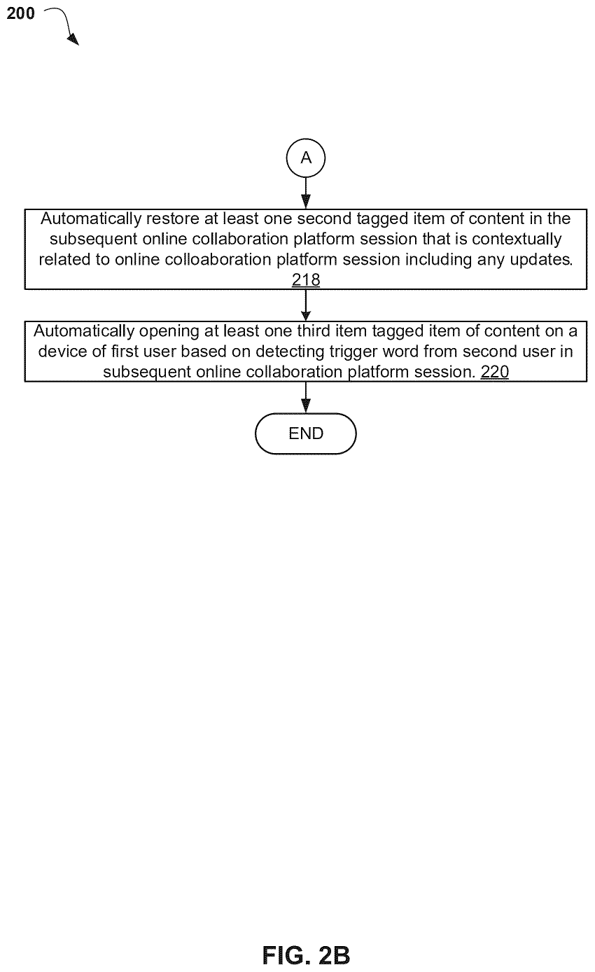

According to the present embodiment, the session management program 150 may be a program capable of receiving real-time and historical data relating to an online collaboration platform session, tagging one or more items of content accessed during the online collaboration platform session and one or more user actions and associate them with the session in a table and, automatically restoring at least one tagged item of content in a subsequent online collaboration platform session that is contextually related to the online collaboration platform session, dynamically restoring relevant content from an original online collaboration platform session without any manual intervention, employing a one-click solution to restore relevant content in a subsequent online collaboration platform session for all users, and enhancing productivity. Furthermore, notwithstanding depiction in computer 101, the session management program 150 may be stored in and/or executed by, individually or in any combination, end user device 103, remote server 104, public cloud 105, and private cloud 106. The session management method is explained in further detail below with respect to FIGS. 2A and 2B. It may be appreciated that the examples described below are not intended to be limiting, and that in embodiments of the present invention the parameters used in the examples may be different.

Referring now to FIGS. 2A and 2B, an operational flowchart for dynamically managing sessions for online collaboration platforms in a dynamic online collaboration platform management process 200 is depicted according to at least one embodiment. At 202, the session management program 150 receives the real-time and historical data relating to the online collaboration platform session. Examples of the online collaboration platform may include, but are not limited to, a video conferencing application, an instant messaging application, an email application, and/or any other application where multiple users collaborate. A session includes a duration of use of the online collaboration platform from start to finish.

The real-time data may include, but is not limited to, an opt-in from the first plurality of users, a request for proposal or request for information for a client, enterprise resources, user profile information, and/or privacy settings. For example, the user profile information may specify the permissions for each of the first plurality of users to review documents. In another example, the enterprise resources may include the various platforms the members of the enterprise have access to, such as what browser and email applications are approved for use.

The historical data may include, but is not limited to, the items of content accessed by the first plurality of users over time, groups of users scheduled to be in the online collaboration platform session together, and/or the time it takes for each user to work on an activity. The historical data may take into account the items of content that are used individually and the items of content that are used collectively. The historical data may be input into and retrieved from a knowledge corpus and/or the database, such as remote database 130. In this manner, the real-time data becomes the historical data upon being input into the knowledge corpus and/or remote database 130.

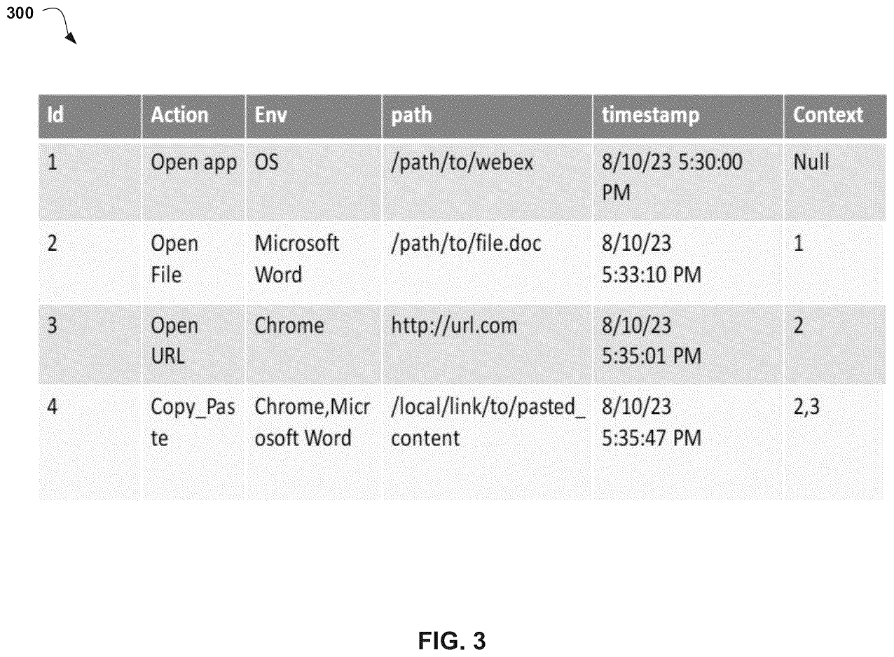

Then, at 204, the session management program 150 tags the one or more items of content accessed during the online collaboration platform session and one or more actions of the first plurality of users. The tagged one or more items of content and the tagged one or more actions may be associated with the online collaboration platform session in a table, as illustrated in FIG. 3. It may be appreciated that the table illustrated in FIG. 3 is an example of the items of content and actions that can be included in the table, and that in embodiments of the present invention additional information may be included in the table. The online collaboration platform session may also be tagged. For example, the online collaboration platform session may be tagged as [Meeting 001]. During the online collaboration platform session, one or more of the first plurality of users may open and interact with the one or more items of content. Examples of the items of content may include, but are not limited to, a pdf document, a web browser, an email application, a word processing application, a bookmark, and/or a URL.

The one or more actions of the first plurality of users may include, but are not limited to, opening a file, opening an application, opening a URL, copying and pasting information between documents, and/or accessing a bookmark. The session management program 150 may utilize containerization to tag the one or more items of content and the one or more actions that occur within the context of the online collaboration platform session. The tagged one or more items of content and the tagged one or more actions may be associated with the online collaboration platform session by inputting and storing them in the table, as illustrated in FIG. 3. For example, the action of opening an application may be tagged as “Open app” and the item of content opened may be tagged as “OS.” The table may be stored in remote database 130. Additional details about the table and the information stored therein are described in further detail below with respect to the description of FIG. 3.

According to at least one embodiment, in addition to tagging the one or more items of content and the one or more actions, the session management program 150 may also identify the context of the online collaboration platform session. The context may be related to the discussion. For example, during the online collaboration session, the first plurality of users may include a patent attorney and a group of inventors discussing an invention. In this example, the context of the online collaboration platform session may be the invention being discussed. In another example, the first plurality of users may include a sales team discussing sales data for the month of July. In this example, the context of the online collaboration platform session may be July sales.

Next, at 206, the session management program 150 adds metadata to one or more actions of a first user that map the one or more actions of the first user to at least one third tagged item of content of the tagged one or more items of content. As used herein, the terms first tagged item of content, second tagged item of content, and third tagged item of content are meant to illustrate that the items of content in each step may or may not include the same information. For example, the first tagged item of content and the second tagged item of content may have at least one common item, have no common items, or have every item in common. The metadata is added based on determining, via NLP, the one or more actions of the first user are performed responsive to a request from a second user during the online collaboration platform session. Using a Bag of Words model or cosine similarity, the session management program 150 may establish that particular actions are performed responsive to requests in the conversation.

For example, during the online collaboration platform session, the second user may send a message to the first user saying “I need the updated sales data for July added to the quarterly report.” Responsive to this request, the first user may open a file called “July_Sales” and another file called “Quarterly_Report” and proceed to copy and paste between the two. The section of the message “Sales data for July” may be tokenized and include metadata with a map to the action “Open July_Sales file” while the section of the message “Quarterly_Report” may include metadata with a map to the action “Open Quarterly_Report file.” This example is continued in further detail below with respect to step 220.

Then, at 208, the session management program 150 determines whether the at least one first tagged item of content of the tagged one or more items of content changes after the conclusion of the online collaboration platform session. The online collaboration platform session may be deemed concluded when the first plurality of users have left the meeting. For example, the first plurality of users may click on a “Leave Meeting” or “End Meeting” button and/or close out of the application hosting the online collaboration platform session. Additionally, the first plurality of users may exit the tagged one or more items of content that were accessed during the online collaboration platform session. For example, the first plurality of users may close out one or more tabs on their browser.

The session management program 150 may compare the at least one first item of tagged content accessed during the online collaboration platform session and the at least one first item of tagged content accessed after the conclusion of the online collaboration platform session to make the determination. For example, the documents accessed during the online collaboration platform session and the documents accessed after the conclusion of the online collaboration platform session may be compared to make the determination.

Based on determining the at least one first tagged item of content changes (step 208, “Yes” branch), the dynamic online collaboration platform management process 200 proceeds to step 210 to update the at least one first tagged item of content to include the new information. Based on determining the at least one first tagged item of content does change (step 208, “No” branch), the dynamic online collaboration platform management process 200 proceeds to step 212 to access the subsequent online collaboration platform session entered into by the second plurality of users.

Next, at 210, the session management program 150 updates the at least one first tagged item of content to include the new information. The at least one first tagged item of content is updated based on the change.

According to at least one embodiment, updating the at least one first tagged item of content to include the new information may include updating the at least one first tagged item of content to include the new information from one or more applications accessed between the online collaboration platform session and the subsequent online collaboration platform session. For example, between the online collaboration platform session and the subsequent online collaboration platform session, one or more of the first plurality of users may open a pdf viewer and begin to make changes to a tagged document. The changes may be recorded and the tag for this document may be updated in the table. In another example, between the online collaboration platform session and the subsequent online collaboration platform session, one or more of the first plurality of users may add additional content to a video played during the online collaboration platform session. Continuing the example, the additional content may be added to the video and the tag for the video may be updated in the table.

According to at least one other embodiment, notes and/or comments may be appended to the at least one tagged item of content based on a discussion among one or more of the first plurality of users between the online collaboration platform session and the subsequent online collaboration platform session. For example, between the online collaboration platform session and the subsequent online collaboration platform session, one or more of the first plurality of users may discuss the contents of a pdf document via email. Continuing the example, notes and/or comments from the email may be appended to the pdf document, and the tag for this document may be updated in the table.

Then, at 212, the session management program 150 accesses the subsequent online collaboration platform session entered into by the second plurality of users. The subsequent online collaboration platform session may take place at a later time than the online collaboration platform session and may be tagged as [Meeting 002]. For example, the subsequent online collaboration platform session may take place a few hours, a few days, a few weeks, or a few months after the online collaboration platform session. The second plurality of users may be the users attending the subsequent online collaboration platform session. The online collaboration platform and the subsequent online collaboration platform may be either the same or a different application. For example, both the online collaboration platform and the subsequent online collaboration platform may be a video conferencing application. In another example, the online collaboration platform may be the video conferencing application and the subsequent online collaboration platform may be an instant messaging application.

As used herein, the terms first plurality of users and second plurality of users are meant to illustrate that the users in the online collaboration platform session and the subsequent online collaboration platform session may or may not include the same users. For example, the online collaboration platform session and the subsequent online collaboration platform session may have at least one common user, have no common users, or have every user in common. The subsequent online collaboration platform session may be accessed when at least one of the second plurality of users enters the meeting.

Next, at 214, the session management program 150 generates the reminder for the at least one user of the second plurality of users to work on the to-do activity within the pre-defined timeframe prior to the subsequent online collaboration platform session. The reminder is generated based on the historical data. The reminder may be a pop-up notification on a device of the at least one user of the second plurality of users that is sent based on the historical data of how long it takes the at least one user to complete the to-do activity. For example, when in the past it took 90 minutes for the at least one user to complete a review of document A, the reminder may be sent 90 minutes prior to the subsequent online collaboration session when the user needs to once again review document A.

According to at least one embodiment, the session management program 150 may schedule or reschedule the subsequent online collaboration platform session based on the time it takes for the at least one user of the second plurality of users to complete the to-do activity. For example, when in the past it took 90 minutes for the at least one user to complete a review of document A, and the at least one user needs to complete the review of document A again, the session management program 150 may may schedule the subsequent online collaboration platform session for 90 minutes after the reminder is generated.

Then, at 216, the session management program 150 generates the summary of the tagged one or more items of content for the at least one user of the second plurality of users having the engagement score below the threshold level. The engagement score may be a numerical score from 1 to 100 and the threshold may be, for example, 50. The at least one user of the second plurality over users may be assigned an engagement score based on their participation in the original online collaboration platform session. Any user that did not participate in the online collaboration platform session may be assigned an engagement score of 0.

According to at least one embodiment, the engagement score may be assigned based on a screen activity, audio activity, keyboard activity, and verbal activity. These activities may indicate the at least one user of the second plurality of users is either distracted from the tagged one or more items of content, away from the online collaboration platform session, or actively engaged in the online collaboration platform session. For example, when the at least one user is gazing at the screen and tapping on their keyboard, the at least one user may be deemed to be distracted from the tagged one or more items of content and assigned an engagement score of 30. Continuing the example, since the engagement score of 30 is below the threshold of 50, the summary may be generated for the at least one user. In another example, the at least one user may be actively speaking throughout the online collaboration platform session and therefore is assigned an engagement score of 90. Continuing the example, since the engagement score of 90 is above the threshold of 50, the summary may not be generated for the at least one user.

Next, at 218, the session management program 150 automatically restores the at least one second tagged item of content of the tagged one or more items of content in the subsequent online collaboration platform session that is contextually related to the online collaboration platform session. As described above, the first tagged item of content and the second tagged item of content may have at least one common item, have no common items, or have every item in common. Similarly, the first tagged item of content, the second tagged item of content, and the third tagged item of content may also have at least one common item, have no common items, or have every item in common. Once the online collaboration platform session has ended, a follow-up discussion (e.g., the subsequent online collaboration platform session) may be scheduled to take place. When the context of the online collaboration platform session matches the context of the subsequent online collaboration platform session, the tagged one or more items of content may be restored during the subsequent online collaboration platform session across the devices of the second plurality of users. For example, when a browser with 5 tabs is opened and tagged during the online collaboration platform session, the browser may be reopened with the 5 tabs during the subsequent online collaboration platform session. In embodiments where the at least one first tagged item of content is updated, the updated version of the items of content may be restored.

According to at least one embodiment, automatically restoring the at least one second tagged item of content in the subsequent online collaboration platform session may include automatically restoring the at least one second tagged item of content based on determining the first plurality of users and the second plurality of users are identical. When the users in the online collaboration platform session and the subsequent online collaboration platform session are identical, there may be a high likelihood that the contexts of the two sessions are related. Accordingly, when the first plurality of users and the second plurality of users are identical, the tagged one or more items of content may be restored across the devices of the users. For example, when the first plurality of users include user A and user B and the second plurality of users include user A and user B, a pdf document tagged during the online collaboration platform session may be restored during the subsequent online collaboration platform session.

According to at least one other embodiment, automatically restoring the at least one second tagged item of content in the subsequent online collaboration platform session may include automatically restoring the at least one second tagged item of content based on words used in the discussion during the subsequent online collaboration platform session. When words used across the session are able to be matched, the contexts of the sessions may be related. For example, during the online collaboration platform session the word “July sales data” may have been spoken or typed. Continuing the example, when the word “July” or words “July sales data” are mentioned again during the subsequent online collaboration platform session, a pdf document tagged during the online collaboration platform session may be restored during the subsequent online collaboration platform session.

According to at least one further embodiment, prior to restoring the tagged one or more items of content, the permissions of the second plurality of users may be analyzed to determine whether the second plurality of users are authorized to view the tagged one or more items of content. When the second plurality of users have authorization, the tagged one or more items of content may be restored. When at least one user of the second plurality of users does not have authorization, permission may be granted by an administrator to restore the tagged one or more items of content on the device of the at least one user.

Then, at 220, the session management program 150 automatically opens the at least one third tagged item of content on a device of the first user during the subsequent online collaboration platform session based on detecting a trigger word from the second user in the subsequent online collaboration platform session. According to at least one embodiment, where the metadata is added to the one or more actions of the first user that map the one or more actions of the first user to the at least one third tagged item of content, the at least one third tagged item of content may be automatically opened upon detection of the trigger word.

For example, during the online collaboration platform session, the second user may send a message to the first user saying “I need the updated sales data for July added to the quarterly report.” Responsive to this request, the first user may open a file called “July_Sales” and another file called “Quarterly_Report” and proceed to copy and paste between the two. The section of the message “Sales data for July” may be tokenized and include metadata with a map to the action “Open July_Sales file” while the section of the message “Quarterly_Report” may include metadata with a map to the action “Open Quarterly_Report file.” During the subsequent online collaboration platform session, the second user may say, “Are you ready to present the quarterly report to the team?” The trigger word “Quarterly Report” may be recognized and the quarterly report file may be restored on the device of the first user, since the action “Open Quarterly_Report file” is mapped to the language “Quarterly_Report.”

Referring now to FIG. 3, an exemplary diagram 300 depicting relevant content stored in a table is shown according to at least one embodiment. In the diagram 300, the table may include the tagged one or more items of content, the tagged one or more actions, a database ID, the path to the tagged one or more items of content, the timestamp at which the tagged one or more items of content are accessed, and/or the context of the tagged one or more items of content.

For example, the action of opening an application may be tagged as “Open app,” the item of content opened may be tagged as “OS,” the path may be tagged as “/path/to/Webex”® (Cisco Webex and all Cisco Webex-based trademarks and logos are trademarks or registered trademarks of Cisco Systems, Inc. and/or its affiliates), the timestamp may be “8/10/23 5:30:00 PM,” the context may be Null, and the database ID may be 1. The action of opening a file may be tagged as “Open File”, the item of content may be tagged as “Microsoft Word”® (Microsoft Word and all Microsoft Word-based trademarks and logos are trademarks or registered trademarks of Microsoft Corporation and/or its affiliates), the path may be tagged as “/path/to/file. doc,” the timestamp may be Aug. 10, 2023 5:33:10 PM,” the context may be 1, and the database ID may be 2. The context being 1 may indicate the “Open File” action is linked to the database ID 1. The action of opening a URL may be tagged as “Open URL,” the item of content may be tagged as “Chrome”® (Chrome and all Chrome-based trademarks and logos are trademarks or registered trademarks of Google LLC and/or its affiliates), the path may be tagged as “http://url.com,” the timestamp may be Aug. 10, 2023 5:35:01 PM,” the context may be 2, and the database ID may be 3. The context being 2 may indicate the “Open URL” action is linked to the database ID 2. The action of copy-paste may be tagged as “Copy_Paste,” the item of content may be tagged as “Chrome®, Microsoft Word®,” the path may be tagged as “/local/link/to/pasted_content,” the timestamp may be Aug. 10, 2023 5:35:47 PM,” the context may be 2, 3, and the database ID may be 4. The context being 2, 3 may indicate the “Copy_Paste” action is linked to the databases IDs 2 and 3.

It may be appreciated that FIGS. 2A, 2B, and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of dynamically managing sessions for online collaboration platforms, the method comprising:
receiving real-time and historical data relating to an online collaboration platform session;
tagging one or more items of content accessed during the online collaboration platform session and one or more actions of a first plurality of users, and associating the tagged one or more items of content and the tagged one or more actions with the online collaboration platform session in a table;
determining whether at least one first tagged item of content of the tagged one or more items of content changes after a conclusion of the online collaboration platform session; and
based on determining the at least one first tagged item of content changes:
updating the at least one first tagged item of content to include new information based on the change;
accessing a subsequent online collaboration platform session entered into by a second plurality of users; and
automatically restoring at least one second tagged item of content of the tagged one or more items of content in the subsequent online collaboration platform session that is contextually related to the online collaboration platform session.

2. The computer-based method of claim 1, further comprising:
based on determining the at least one first tagged item of content does not change:
accessing the subsequent online collaboration platform session entered into by the second plurality of users; and
automatically restoring the at least one second tagged item of content in the subsequent online collaboration platform session that is contextually related to the online collaboration platform session.

3. The computer-based method of claim 2, further comprising:
adding metadata to one or more actions of a first user that map the one or more actions of the first user to at least one third tagged item of content of the tagged one or more items of content based on determining, via natural language processing (NLP), the one or more actions of the first user are performed responsive to a request from a second user during the online collaboration platform session; and
based on detecting a trigger word from the second user in the subsequent online collaboration platform session, automatically opening the at least one third tagged item of content on a device of the first user during the subsequent online collaboration platform session.

4. The computer-based method of claim 2, wherein automatically restoring the at least one second tagged item of content in the subsequent online collaboration platform session further comprises:
automatically restoring the at least one second tagged item of content based on determining the first plurality of users and the second plurality of users are identical.

5. The computer-based method of claim 2, wherein updating the at least one first tagged item of content to include the new information further comprises:
updating the at least one first tagged item of content to include the new information from one or more applications accessed between the online collaboration platform session and the subsequent online collaboration platform session.

6. The computer-based method of claim 2, further comprising:
generating a reminder for at least one user of the second plurality of users to work on a to-do activity within a pre-defined timeframe prior to the subsequent online collaboration platform session based on the historical data.

7. The computer-based method of claim 2, further comprising:
generating a summary of the tagged one or more items of content for at least one user of the second plurality of users having an engagement score below a threshold level.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving real-time and historical data relating to an online collaboration platform session;
tagging one or more items of content accessed during the online collaboration platform session and one or more actions of a first plurality of users, and associating the tagged one or more items of content and the tagged one or more actions with the online collaboration platform session in a table;
determining whether at least one first tagged item of content of the tagged one or more items of content changes after a conclusion of the online collaboration platform session; and
based on determining the at least one first tagged item of content changes:
updating the at least one first tagged item of content to include new information based on the change;
accessing a subsequent online collaboration platform session entered into by a second plurality of users; and
automatically restoring at least one second tagged item of content of the tagged one or more items of content in the subsequent online collaboration platform session that is contextually related to the online collaboration platform session.

9. The computer system of claim 8, the method further comprising:
based on determining the at least one first tagged item of content does not change:
accessing the subsequent online collaboration platform session entered into by the second plurality of users; and
automatically restoring the at least one second tagged item of content in the subsequent online collaboration platform session that is contextually related to the online collaboration platform session.

10. The computer system of claim 9, the method further comprising:
adding metadata to one or more actions of a first user that map the one or more actions of the first user to at least one third tagged item of content of the tagged one or more items of content based on determining, via natural language processing (NLP), the one or more actions of the first user are performed responsive to a request from a second user during the online collaboration platform session; and
based on detecting a trigger word from the second user in the subsequent online collaboration platform session, automatically opening the at least one third tagged item of content on a device of the first user during the subsequent online collaboration platform session.

11. The computer system of claim 9, wherein automatically restoring the at least one second tagged item of content in the subsequent online collaboration platform session further comprises:
automatically restoring the at least one second tagged item of content based on determining the first plurality of users and the second plurality of users are identical.

12. The computer system of claim 9, wherein updating the at least one first tagged item of content to include the new information further comprises:
updating the at least one first tagged item of content to include the new information from one or more applications accessed between the online collaboration platform session and the subsequent online collaboration platform session.

13. The computer system of claim 9, the method further comprising:
generating a reminder for at least one user of the second plurality of users to work on a to-do activity within a pre-defined timeframe prior to the subsequent online collaboration platform session based on the historical data.

14. The computer system of claim 9, the method further comprising:
generating a summary of the tagged one or more items of content for at least one user of the second plurality of users having an engagement score below a threshold level.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving real-time and historical data relating to an online collaboration platform session;
tagging one or more items of content accessed during the online collaboration platform session and one or more actions of a first plurality of users, and associating the tagged one or more items of content and the tagged one or more actions with the online collaboration platform session in a table;
determining whether at least one first tagged item of content of the tagged one or more items of content changes after a conclusion of the online collaboration platform session; and
based on determining the at least one first tagged item of content changes:
updating the at least one first tagged item of content to include new information based on the change;
accessing a subsequent online collaboration platform session entered into by a second plurality of users; and
automatically restoring at least one second tagged item of content of the tagged one or more items of content in the subsequent online collaboration platform session that is contextually related to the online collaboration platform session.

16. The computer program product of claim 15, further comprising:
based on determining the at least one first tagged item of content does not change:
accessing the subsequent online collaboration platform session entered into by the second plurality of users; and
automatically restoring the at least one second tagged item of content in the subsequent online collaboration platform session that is contextually related to the online collaboration platform session.

17. The computer program product of claim 16, the method further comprising:
adding metadata to one or more actions of a first user that map the one or more actions of the first user to at least one third tagged item of content of the tagged one or more items of content based on determining, via natural language processing (NLP), the one or more actions of the first user are performed responsive to a request from a second user during the online collaboration platform session; and
based on detecting a trigger word from the second user in the subsequent online collaboration platform session, automatically opening the at least one third tagged item of content on a device of the first user during the subsequent online collaboration platform session.

18. The computer program product of claim 16, wherein automatically restoring the at least one second tagged item of content in the subsequent online collaboration platform session further comprises:
automatically restoring the at least one second tagged item of content based on determining the first plurality of users and the second plurality of users are identical.

19. The computer program product of claim 16, wherein updating the at least one first tagged item of content to include the new information further comprises:
updating the at least one first tagged item of content to include the new information from one or more applications accessed between the online collaboration platform session and the subsequent online collaboration platform session.

20. The computer program product of claim 16, the method further comprising:
generating a reminder for at least one user of the second plurality of users to work on a to-do activity within a pre-defined timeframe prior to the subsequent online collaboration platform session based on the historical data.
